(19) United States
(12) Patent Application Publication
(10) Pub. No.: US 2011/0104325 A1
(43) Pub. Date: May 5, 2011

(54) FISH ATTRACTANT

(75) Inventor: Charles Olsson, (US)

(73) Assignee: 4 Season Company Pty Ltd, Crestmead (AU)

(21) Appl. No.: 12/914,262

(22) Filed: Oct. 28, 2010

(30) Foreign Application Priority Data
Nov. 5, 2009 (AU) 2009905407

(51) Int. Cl. A01K 97/04

(52) U.S. Cl. 426/1

(57) ABSTRACT

A fish attractant (1) in the form of a compacted composite (2) which comprises a binding matrix containing one or more fish attracting ingredients, wherein the binding matrix releases the fish attracting ingredients at a substantially uniform rate once placed in the water.

### RELATED APPLICATION

This application claims priority from Australia provisional patent application No. 2009905407 filed Nov. 5, 2009.

### TECHNICAL FIELD

This invention relates to a fish attractant (also known colloquially as a burley block or chum block) and a method of manufacturing the fish attractant. In particular, the invention concerns a fish attractant in the form of a compacted composite which comprises a binding matrix containing one or more fish attracting ingredients, wherein the binding matrix releases the fish attracting ingredients at a substantially uniform rate once placed in a body of water.

### BACKGROUND ART

Different forms of burley or chum blocks are known. In one form, the ‘block’ typically comprises a container (mesh or bottle) loosely filled with fish attracting ingredients, such as blended fish meal and grain proteins. Once placed in a body of water, the fish attracting ingredients escape to the body of water through one or more openings in the container. In another form, the block is a block of ice containing fish attracting ingredients. Once placed in a body of water, the block of ice melts and the fish attracting ingredients are released into the body of water.

Disadvantages of the above mentioned types of burley or chum blocks include that they can release the fish attracting ingredients other than at a desired rate (normally too quickly or sporadically), or they can be inconvenient to transport or store.

### DISCLOSURE OF THE INVENTION

An object of the present invention is to provide a fish attractant that overcomes or minimizes a disadvantage referred to above, or to provide the public with a useful or commercial choice.

According to a first aspect of the present invention, there is provided a fish attractant in the form of a compacted composite comprising:
a binding matrix; and
at least one type of fish attracting ingredient dispersed within the binding matrix and releasable from the binding matrix at a substantially uniform rate once placed in a body of water.

According to a second aspect of the present invention, there is provided a method of manufacturing a fish attractant in the form of a compacted composite, said method comprising the steps of:
mixing at least one type of fish attracting ingredient with at least one binding matrix former to form a mixture; and,
compacting the mixture so as to form a compacted composite fish attractant comprising the at least one type of fish attracting ingredient dispersed within a binding matrix formed by the at least one binding matrix former, wherein the at least one type of fish attracting ingredient is releasable from the binding matrix at a substantially uniform rate once placed in a body of water.

Although the terms “fish attractant” and “fish attracting ingredient” have been used for convenience sake, it is to be appreciated that the terms may encompass other mobile aquatic creatures that are not strictly speaking fish (e.g. crustaceans and mammals). That is, the fish attractant of the present invention may be used to attract crabs, prawns, shellfish, turtles, seals, dolphins and porpoises.

The compacted composite may be of any suitable size, weight and shape. The compacted composite may be, for example, cylindrical, spherical or rectangular. The compacted composite may be, for example, 0.5-5.0 kg in weight.

The size, shape and weight will depend on its intended use, including the type of fish (or other type of mobile aquatic creature) to be attracted, as well as the nature of the body of water—beach, river, lake, ocean, sea water, freshwater, tidals conditions or water currents, etc.

Preferably, the compacted composite is in the shape of a brick having a weight of about 2 kg.

The compacted composite may be buoyant or not. Preferably, the compacted composite is not buoyant and can be suspended by a line/tethered. This may be achieved in any suitable way. For example, the fish attractant may include a tethering device that is connected to or integrally formed with the compacted body. In one embodiment, the tethering device may have a body extending through the compacted composite and a hook or eyelet located externally of the body to which a tether line may be tied. The tethering device is preferably made of a biodegradable material, such as mild steel.

Any suitable type of fish attracting ingredient may be used. The fish attracting ingredient may produce a fish-attracting scent in the body of water and/or it may be something that is actually consumed by fish, eg. food in particulate form.

In one embodiment, the fish attracting ingredient may be fish meal.

In another embodiment, the fish attracting ingredient may be fish oil, such as tuna oil.

In yet another embodiment, the fish attracting ingredient may comprise vegetal matter or vegetable byproduct. The ingredient may comprise, for example, grain protein, wheat byproduct, cottonseed meal or dry brewer's grain.

Preferably, the fish attractant comprises more than one type of fish attracting ingredient, such as a mixture of grain protein and fish meal. Preferably, the compacted composite comprises about 10% by weight grain protein and about 10% by weight fish meal.

Other potential fish attracting ingredients include, for example, bread, meat and poultry—as used in known burley blocks. The choice of ingredients is virtually limitless and will largely depend on the types of fish that are to be attracted.

Any suitable type of binding matrix former may be used, provided that the fish attracting ingredient is dispersible/mixable within the binding matrix and releasable from the binding matrix at a substantially uniform rate once placed in the body of water. Examples of binding matrix formers include pitches, sulfite liquor, molasses and lime, and other sticky viscous fluids.

In a preferred embodiment, the binding matrix comprises molasses and hydrated lime as the matrix formers. Although hydrated lime may be excluded from the fish attractant, its inclusion will typically result in the compacted composite having greater water resistance and thus slower disintegration of the compacted composite in the body of water, such that the fish attracting ingredients may be released from the binding matrix at a slower rate.

It is presently believed that the binding matrix is formed by molasses and hydrated lime interacting in one of two ways: (1) The hydrated lime reacts with carbon dioxide in air, thereby producing calcium carbonate and water, and the molasses acts as a catalyst and the calcium carbonate gives the compacted composite the required strength. (2) The molasses reacts with hydrated lime to form calcium sucrates.

Any suitable ratio of molasses to hydrated lime may be used, and higher amounts of hydrated lime will generally equate with the compacted composite having greater water resistance/slower rate of disintegration and fish attracting ingredient release. Preferably, the fish attractant comprises at least about 0.5% by weight hydrated lime and more preferably at least about 1.5% by weight hydrated lime. (The degree of compaction will also have a bearing on the water resistance of the compacted composite.) Preferably, the compacted composite comprises a total amount of about 15% by weight molasses and hydrated lime.

The compacted composite of the fish attractant can comprise one or more additional types of ingredients. Such ingredients may include, for example, fragrances (odour reducers), colourants, desiccants (for longer shelf life), preservatives (for longer shelf life) and fillers/bulking agents—providing that the attractant properties are not adversely affected.

The fish attractant may comprise a filler/bulking agent and any suitable type of filler may be used. In a preferred embodiment, the filler is salt which adds weight to the compacted composite and renders it non-buoyant. Preferably, the compacted composite comprises about 65% by weight salt, such as sodium chloride.

The compacted composite may be compacted in any suitable way, using any suitable compacting machinery and compacting pressure. Such machinery may be as used for forming nutritional blocks for livestock.

Preferably, a mixture of the fish attracting ingredient and binding matrix former (and any other ingredient) is used to fill a mould, and the mixture is compressed under about 50 to 200 metric tons of pressure. If the fish attractant includes a tethering device, then the body of the device may be located within the mould at the time of compaction.

Varying the binding matrix and compaction pressure can alter the disintegration rate and thus the rate of release of the fish attracting ingredients. It some instances it may be desirable to have a compacted composite that is highly water resistant and will only disintegrate after about six hours, thus releasing fish attractants at a relatively slow rate. In other instances it may be desirable to have a compacted composite that is less water resistant and will release fish attractants at a faster rate—say, with disintegration of the compacted composite occurring within about two to three hours.

According to a third aspect of the present invention, there is provided a method of attracting fish, said method comprising the step of placing a fish attractant in the form of a compacted composite within a body of water containing fish, wherein the compacted composite comprises:
a binding matrix; and
at least one type of fish attracting ingredient dispersed within the binding matrix and releasable from the binding matrix at a substantially uniform rate once placed in the body of water.

Preferably, the fish attractant may be suspended in the body of water. The fish attractant may be suspended in the body of water by placing the fish attractant in a container or mesh bag and lowering the container or mesh bag into the body of water. Alternatively, the fish attractant may be directly suspended in the body of water by way of a line or tethering device incorporated into the fish attractant.

According to a first preferred aspect, there is provided a fish attractant in the form of a compacted composite block comprising:
approximately 15% by weight binding matrix comprising molasses and hydrated lime;
approximately 65% by weight salt dispersed within the binding matrix; and
fish attracting ingredients comprising approximately 10% by weight in and approximately 10% by weight fish meal dispersed within the binding matrix and releasable from the binding matrix at a substantially uniform rate once placed in a body of water.

According to a second preferred aspect of the present invention, there is provided a method of manufacturing a fish attractant in the form of a compacted composite block, said method comprising the steps of:
mixing approximately 65% by weight salt and fish attracting ingredients comprising approximately 10% by weight grain protein and approximately 10% by weight fish meal to form and non-binder mixture;
mixing the non-binder mixture with approximately 15% by weight binding matrix formers for forming a binding matrix, comprising molasses and hydrated lime so as to form a binder mixture, such that the salt and fish attracting ingredients are dispersed within the binding matrix;
compacting the binder mixture under approximately 200 metric tons of pressure to form a compacted composite; and
allowing the compacted composite to set such that the fish attracting ingredients are releasable from the binding matrix at a substantially uniform rate once placed in a body of water.

Preferred embodiments of the invention will now be described by way of reference to the accompany example and figures. These example and figures are for the purpose of illustration only and are not to be construed as limiting the scope of the invention in any manner.

### BRIEF DESCRIPTION OF THE FIGURES

FIG. 1 is a detailed perspective view of a fish attractant, according to an embodiment of the present invention; and

FIG. 2 is a detailed perspective view of compacting machinery for preparing the fish attractant shown in FIG. 1.

### BEST MODES FOR CARRYING OUT THE INVENTION

### Example

### Preparation of a Fish Attractant in the Form of a Compacted Composite

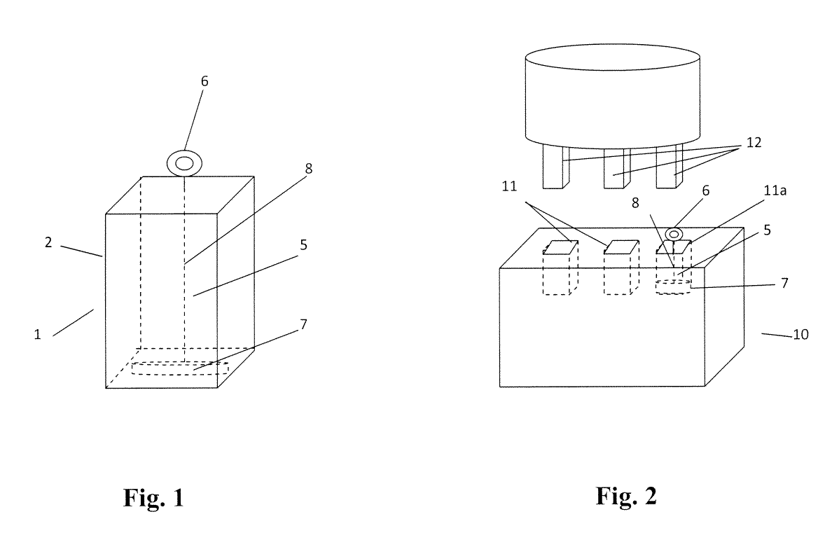

This example describes the preparation of a fish attractant 1 comprising a compacted composite block 2 and tethering device 5 as shown in FIG. 1, according to an embodiment of the present invention.

Salt (65% by weight) and fish attracting ingredients (10% by weight grain protein, dry brewer's grain, cottonseed meal or vegetable byproduct or mixtures thereof; and 10% by weight fish meal, optionally with tuna oil) were mixed for about five minutes using a ribbon mixer to form a non-binder mixture.

Binding matrix formers, for forming a binding matrix, comprising molasses and hydrated lime (totaling 15% by weight), were mixed with the non-binder mixture until a substantially homogenous binder mixture was produced. That is, the salt and fish attracting ingredients were substantially homogeneously dispersed within the binding matrix.

The binder mixture was then emptied into a surge bin and used to fill (three) rectangular shaped moulds 11 of compacting machinery 10. Each mould 11 contained the tethering device 5 of the fish attractant 1 (shown only for mould 11a).

The tethering device 5 has an eyelet 6 located adjacent a top of the mould 11a and a body extending from the eyelet 6 through the binder mixture to a bottom of the mould 11a. The body comprises an anchoring plate 7 located at the bottom of the mould 11a and a shaft or wire 8 extending from the anchoring plate 7 to the eyelet 6. The tethering device 5 is made of biodegradable mild steel.

A hydraulically powered punch head 12 of the machinery 10 then compacted the binder mixture under 200 metric tons of pressure to form a compacted composite 2 which incorporated the body of the tethering device 5. After about 12 hours, the composite body 2 set/fully solidified and was ready for use. Compaction decreased void spaces of the composite 2, and thus increasing the ingredient binding strength and water resistance of the composite 2.

In use, the eyelet 6 of the fish attractant 1 is tied to tether line and placed within a marine environment or suspended from a boat, for example. Due to the nature of the binding matrix and compaction, the fish attracting ingredients are releasable from the binding matrix into the marine environment at a substantially uniform rate so as to attract fish in a vicinity of the fish attractant 1.

Varying the binding matrix and compaction pressure can alter the disintegration rate and thus the rate of release of the fish attracting ingredients. It some instances it may be desirable to have a compacted composite that is highly water resistant and will only disintegrate after about six hours, thus releasing fish attractants at a relatively slow rate. In other instances it may be desirable to have a compacted composite that is less water resistant and will release fish attractants at a faster rate—say, with disintegration of the compacted composite occurring within about two to three hours.

The invention as exemplified thus minimizes the disadvantages of known burley or chum blocks that release their fish attracting ingredients too rapidly or too sporadically. Since the invention as exemplified will not disintegrate when kept at ambient temperature (above freezing) and in dry conditions, it also does not have the disadvantage of frozen burley or chum blocks which must be kept frozen, else they will disintegrate.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

Any reference to publications cited in this specification is not an admission that the disclosures constitute common general knowledge in Australia or elsewhere.

1. A fish attractant in the form of a compacted composite comprising:
a binding matrix; and
at least one type of fish attracting ingredient dispersed within the binding matrix and releasable from the binding matrix at a substantially uniform rate once placed in a body of water.

2. The fish attractant of claim 1, wherein the fish attracting ingredient is selected from the group consisting of fish meal, fish oil, vegetal matter, vegetal byproduct, grain protein, wheat byproduct, cottonseed meal and dry brewer's grain.

3. The fish attractant of claim 1, wherein the at least one fish attracting ingredient comprises a mixture of grain protein and fish meal.

4. The fish attractant of claim 1, wherein the at least one fish attracting ingredient comprises a mixture of grain protein, fish meal and fish oil.

5. The fish attractant of claim 1, wherein the binding matrix comprises molasses and hydrated lime.

6. The fish attractant of claim 1 further comprising a bulking agent.

7. The fish attractant of claim 6, wherein the bulking agent is salt.

8. The fish attractant of claim 1, wherein the compacted composite is shaped and sized so as to be containable in a container or mesh bag.

9. The fish attractant of claim 1, wherein the at least one fish attracting ingredient is releasable from the binding matrix over a period of at least 2 hours.

10. The fish attractant of claim 1 comprising:
approximately 15% by weight binding matrix comprising molasses and hydrated lime;
approximately 65% by weight salt dispersed within the binding matrix;
fish attracting ingredients comprising approximately 10% by weight in and approximately 10% by weight fish meal dispersed within the binding matrix and releasable from the binding matrix at a substantially uniform rate once placed in a body of water.

11. A method of manufacturing a fish attractant in the form of a compacted composite, said method comprising the steps of:
mixing at least one type of fish attracting ingredient with at least one binding matrix former to form a mixture; and
compacting the mixture so as to form a compacted composite fish attractant comprising the at least one type of fish attracting ingredient dispersed within a binding matrix formed by the at least one binding matrix former, wherein the at least one type of fish attracting ingredient is releasable from the binding matrix at a substantially uniform rate once placed in a body of water.

12. The method of claim 11, wherein the mixture is compacted within a mould under about 50 to 200 metric tons of pressure.

13. The method of claim 11, wherein the binding matrix and compaction pressure are varied so as to either increase or decrease the rate of release of the at least one type of fish attracting ingredient from the binding matrix.

14. The method of claim 11, wherein the at least one fish attracting ingredient is releasable from the binding matrix over a period of at least 2 hours.

15. The method of claim 11, herein the mixture comprises: approximately 65% by weight salt, approximately 10% by weight grain protein, approximately 10% by weight fish meal and approximately 15% by weight molasses and hydrated lime.

16. A method of attracting fish, said method comprising the step of placing the fish attractant as claimed in claim 1 within a body of water containing fish.

17. The method of claim 16, wherein the fish attractant is suspended in the body of water by way of a tethered container or mesh bag.
